(19) United States
(12) Patent Application Publication
(10) Pub. No.: US 2007/0017981 A1
(43) Pub. Date: Jan. 25, 2007

(54) Device and method for transferring information

(76) Inventor: Alfred Langerak, Mijnsheerenland (NL)

Correspondence Address: HOFFMANN & BARON, LLP, 6900 JERICHO TURNPIKE, SYOSSET, NY, 11791, US

(21) Appl. No.: 10/568,024

(22) PCT Filed: Aug. 13, 2004
(86) PCT No.: PCT/NL04/00577

§ 371 Date: Jun. 19, 2006

(30) Foreign Application Priority Data
Aug. 13, 2003 (NL) 1024102

(51) Int. Cl. G06K 15/00

(52) U.S. Cl. 235/383

(57) ABSTRACT

The invention relates to an information carrier (1) a of type on which electronic information can be provided, such as a DVD or CD rewritable or recordable or a diskette, which information carrier is substantially free of such electronic information, while on a surface of the information carrier and/or in electronic form at least one commercial message (5) has been provided which is not related to the supplier or producer of the respective information carrier.

The invention relates to a device for transferring information.

Nowadays, for people and companies, the transfer of information has become exceptionally important. Messages of an informative nature such as commercial messages, safety regulations, health information and the like are transferred also in situations in which they are not directly applicable.

The object of the invention is a device for transferring information. To that end, a device according to the invention is characterized by the features of claim 1.

An information carrier according to the invention is primarily suitable and intended for recording and playing electronic information once or repeatedly, in particular with the aid of light, in a player destined thereto such as a CD, DVD or a CD-ROM player or a diskette drive. As a rule, such information carriers are supplied to users in blank condition, while blank is understood to mean substantially without electronic information stored therein, and will further also be indicated as ‘unrecorded’. Except for the name of the supplier and, optionally, a type indication, the outer surfaces of the information carrier are usually blank. According to the invention, on such an outer surface of an information carrier, a promotional message is provided which is not related to the supplier or producer of the information carrier. Surprisingly, it has appeared that during use of the information carrier, in particular when the information carrier is inserted into and/or taken out of a player destined thereto, the user assimilates the information contained in the respective commercial message unconsciously and in a direct manner without, to that end, having to make any effort. In particular when the user repeatedly inserts the information carrier into a player and takes it out, the promotional message will be assimilated by him and be processed consciously or unconsciously. Preferably, the promotional message is provided on the side normally facing upwards.

In an alternative embodiment, a promotional message has been provided on the information carrier in electronic form, so that, at least when the information carrier is used for the first time, this promotional message will be shown on, for example, a screen. Also, combinations of a promotional message provided on a surface of the information carrier and one in electronic form can be utilized.

In an advantageous embodiment, a device according to the invention is further characterized by the features of claim 3.

The information carrier can for instance be disc-shaped, i.e. formed like a CD yet without central opening. As a result, a greater surface is obtained so that more space is available for the promotional message, further information and, optionally, for electronic information. This use is based on the insight that the central opening as it is known with the normal CD for playing information provided thereon, is not requisite. This insight can also be used generally for CDs, for enlarging the capacity. Optionally, a detachable or breakaway part can be included centrally in the information carrier such that, if desired, after removal of this part, in a customary manner, a central opening is provided. The removed part can optionally be used as collectible or the like, provided with at least a part of the promotional message, for instance a logo. Preferably, only a part of the information carrier is provided with the promotional message, so that another part is available for, for instance, information to be provided by the user.

According to the invention, a promotional message can also be visible on the side of the information carrier which, during use, is readable by light. In such an embodiment, the promotional message is provided so as to be transparent. Herein, transparent is understood to include at least transmitting to the light with which the information of the information carrier is to be read. The colours can then be geared to the frequency of the light used for reading out, so that this light is not influenced by the promotional message. Preferably, the message is provided on one of the surfaces of the transparent disc on which chemical layers and coatings such as reflection layers are provided for building up a CD or DVD, in particular recordable or rewritable. Preferably, the promotional message is provided on the side thereof facing outwards, in particular by in mold labelling.

Instead of or, preferably, in addition to the promotional message on the information carrier, a similar or comparable promotional message can be provided on a package for the information carrier.

For, for instance, promotional actions and the like such as sweepstakes, of a series of information carriers and/or packages of the present type, a limited number can be provided with a promotional message according to the invention. Such a promotional message can then, for that matter, also be a numerical or alphanumerical indication or a different sort of indicator. The respective information carrier or package with the respective promotional message can then be linked to a prize for a user. For instance, the respective information carrier with promotional message can be used as a ticket in a lottery or as a collectible. Preferably, the information carrier and/or packages are then packaged such that the promotional message is not visible from the outside. This can be done particularly simply if the commercial message has been provided in electronic form. Naturally, also varying promotional messages can be provided, while different promotional messages lead to, for instance, different prizes.

The invention further relates to a method for transferring information such as a promotional message. Surprisingly, it has appeared that through the very provision of a commercial message in words and/or pictures on an information carrier such as a CD, information can be transferred in a suitable manner, simply and without effort for the receiver. Without wishing to be bound to any theory, this seems to be the result of the effect that the promotional message is assimilated in the subconscious virtually inadvertently. As a result of, in particular, repetition, such a promotional message is assimilated well.

The commercial message can be provided in the form of text as well as in the form of image or the like, or in a combination thereof. On the information carrier, preferably, the commercial message as well as the electronic information to be provided to the information carrier itself or to be provided thereon are provided, at least space is offered to that end. For instance, a field can be provided on the surface of the information carrier on which information can be provided independently by a user, for instance written, printed or pressed.

The invention further relates to a method for advertising, in which on an information carrier a promotional message is provided, not related to the producer of the information carrier. This entails at least that the manufacturer of information carriers offers third parties promotional space on the information carriers manufactured, at least to be manufactured, by him. This is suitable in particular for unrecorded information carriers such as CD or DVD recordables and rewritables or for diskettes and mini discs. This space can be offered on a surface of the respective information carrier or in electronic form.

Furthermore, the invention relates to a method for organizing a lottery or collecting campaign, wherein at least one information carrier according to the invention is used as a lottery ticket or collectible.

The invention further relates to a method for providing a promotional message on an information carrier such as, for instance, a CD.

With such a message, in a particularly simple and practical manner, a medium is presented to third parties to make messages available to many people. Such messages are eminently suitable for promotional purposes. Preferably, the or each respective message is provided through in mold labelling during manufacture of the information carrier, in particular by injection molding.

In the further subclaims, advantageous embodiments of a method or device according to the invention are shown. In clarification of the invention, exemplary embodiments of the invention will be further elucidated with reference to the drawing. In the drawing:

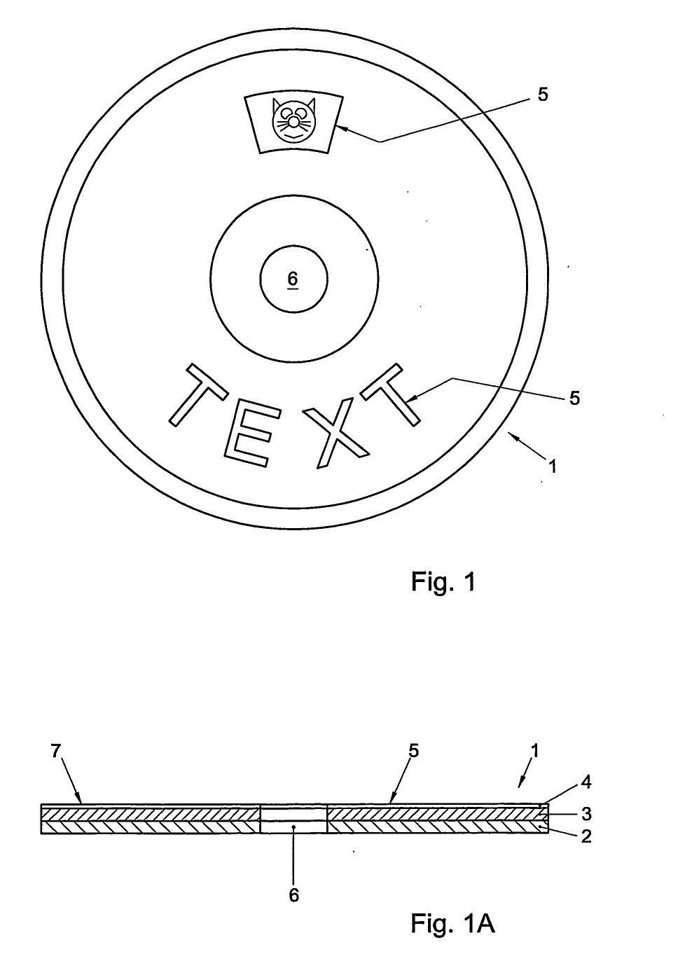

FIG. 1 shows, in front view, an information carrier according to the invention, in the form of a CD;

FIG. 1A shows and information carrier according to any one of the FIGS. 1-4 in partial side view;

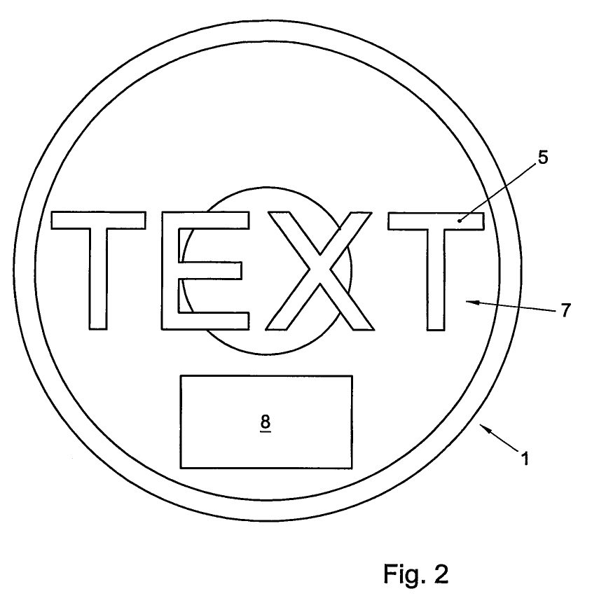

FIG. 2 shows, in front view, a first alternative embodiment of an information carrier according to the invention;

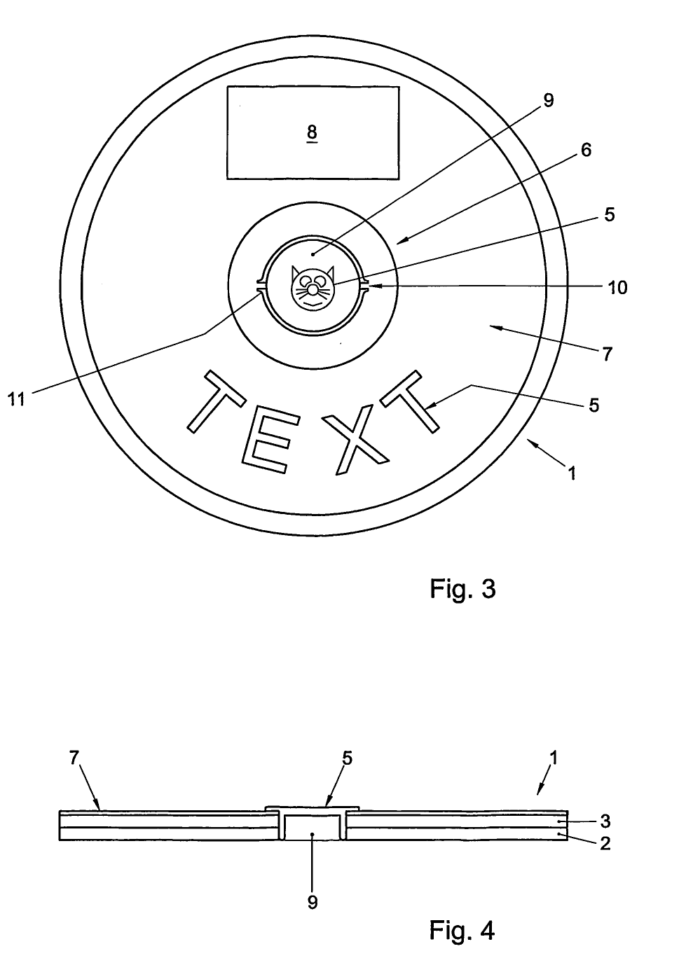

FIG. 3 shows, in front view, a second alternative embodiment of an information carrier according to the invention;

FIG. 4 shows an alternative embodiment of an information carrier according to FIG. 3;

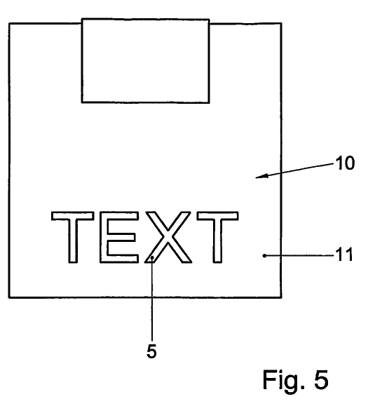

FIG. 5 shows, in front view, a third alternative embodiment of an information carrier according to the invention, in the form of a diskette; and

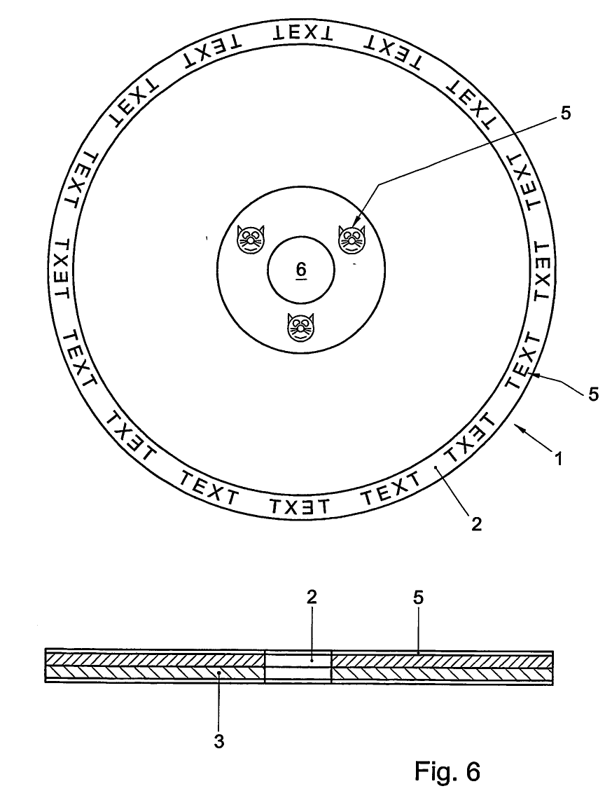

FIG. 6 shows a fourth alternative embodiment of an information carrier according to the invention, in rear view and partial cross section.

In this description, identical or corresponding parts have identical or corresponding reference numerals. The embodiments shown are shown only as examples and should not be construed to be limitative in any manner. Herein, information carrier is at least understood to include CDs and such disc-shaped information carriers and diskettes which are readable electronically, in particular with the aid of light, in particular recordable and rewriteable CDs and DVDs. Hereinafter, for the sake of simplicity, these will all be indicated as “CD”. In this description, unrecorded or such wording is understood to include at least CDs and the like containing virtually no electronically readable information, at least information readable with the aid of light. On the contrary, for instance so-called grooves can be provided for guiding reading heads and the like, information on or instance tracks, groove width, diameter of the information carrier, formattings and the like and, optionally, a short promotional message or the like which takes up relatively little electronic space on the information carrier and is preferably removable. However, the invention is not limited to such unrecorded information carriers.

FIG. 1 shows, in front view, an information carrier 1 according to the invention, in the form of a regular CD recordable or rewritable. The CD 1 is shown from the side from which the CD 1 is not read in a device designed to that end such as a CD or DVD player, CD or DVD writer or the like. As a rule, a CD is built up such that a transparent, circular disc 2 with a central opening 6 is provided on one side with a layer 3 which is reflective and/or influenceable by light from the respective device designed to that end, as is schematically shown in side view in FIG. 1A. With an information carrier 1 according to the invention, on the side of the layer 3 remote from the disc, a print 4 is provided in the form of a message 5. In the exemplary embodiment shown, this message has been provided in the form of a logo and text as advertisement. However, this message can also contain, for instance, a text and/or figures in the form of information on products, services and the like. The respective message 5 is not related to the producer of the CD 1. Preferably, the CD is unrecorded and of a recordable or rewriteable type as known from practice.

In FIG. 2, a first alternative embodiment of a CD 1 according to the invention is shown, again provided with a promotional message 5 and, as to design, comparable to the one according to FIGS. 1 and 1A. However, in this embodiment, no central opening 6 is provided but the entire face of the CD is closed. As a result, a relatively great surface 7 is available for the promotional message 5 and, optionally, a field 8 on which, by a user of the CD 1, information can be written, printed or the like, for instance about recorded data.

In FIG. 3, a second alternative embodiment of a CD 1 according to the invention is shown, again provided with one message 5 and, as to design, comparable to the one of FIG. 1 and 1A and 2. However, in this embodiment, in the central opening 6, a disc-shaped element 9 is provided which is detachable for clearing the central opening 6. As a result, a relatively great surface 7 is available for the promotional message 5 and, optionally, a field 8 on which, by a user of the CD 1, information can be written, printed or the like, for instance about recorded data. Preferably, the promotional message 5 is partly, and optionally wholly, included on this element 9, such that the promotional message is clearly visible. If desired, for instance when the CD is to be used in a player with a provision for positioning, in particular centring the CD with the aid of this opening, this element 9 can be removed from the CD. The element 9 itself can then for instance be a collectible such as a Flippo, with a picture 9A thereon as shown in FIG. 3.

In the exemplary embodiment shown in FIG. 3, the element 9 is formed integrally with the CD and fixed in the opening 6 with the aid of thin bridges 10 which can be broken or cut loose or cut with scissors in a simple manner. As the bridges continue to some extent in the recesses 11 in the rim of the opening 6, bothersome burrs can simply be avoided. However, naturally, other manners of securing can be used too. Also, the element can be formed separately from the CD and, as shown in FIG. 4, be provided as, for instance, a cap in the opening and be secured with the aid of, for instance, release glue or by clamp fitting or form fitting. In that case, the element 9 can be designed to be, for instance, slightly flexible, for instance from thermoplastic plastic, in particular with elastomeric properties. Also, the element 9 can have a rigid core and a soft outer edge, so that the outer edge can be pressed into the opening for temporary securing. Such an element can for instance be manufactured through 2K injection molding.

Different elements 9 can be provided with different messages 5, for instance pictures, so that they can become collectibles. The elements 9 can also be designed such that therewith, different information carriers can be stacked.

In FIG. 5, an alternative embodiment of a information carrier according to the invention is shown, in the form of a diskette or minidisk 10. Here, on the outside of the housing 11, a message as earlier described has been provided.

It is clear that the message 5 is not related to the manufacturer of the CD or to the supplier thereof or, optionally, the producer. The message 5 is for instance a promotional expression of a sports equipment manufacturer, a beverage or cigarette brand, a clothing supplier or the like or a different message of informative nature of, for instance, a cultural institution or a health institution.

According to the invention, preferably, the CDs are manufactured by a first offeror, in a manner known per se, while from a second offeror promotional messages 5 are collected which are provided on the CDs. As indicated hereinabove, this second offeror is, for instance, a supplier of consumer goods, a cultural or health institution or the like. Thereupon, the CDs are supplied to users and/or third offerors such as wholesalers which supply the CDs to users. The users insert the CDs in playback equipment and/or recording equipment while each time when inserting in and/or taking out and/or starting the CD, the promotional message is sensed by the user, at least unconsciously, so that, surprisingly, it has appeared that the promotional message is rapidly assimilated by the user virtually without the user, to that end, having to make any effort. Due to the manner of providing the commercial message 5, this does not influence playing the CD.

In FIG. 6, in rear view and partial cross section, an information carrier 1 according to the invention is shown, wherein the promotional message 5 has been provided such that it is visible from the side to be read, during use, by light, which side is indicated herein as rear side. The promotional message has been applied in colour transparent to the light of a player suitable for reading out the information carrier. The colour is geared to the frequency of the light mentioned such that this light is not hindered by the respective print. As appears from the cross section, the promotional message 5 in the exemplary embodiment shown has been applied through in mold labelling on the transparent disc, for instance poly carbonate, on which the chemical layers and/or the reflection layers and/or the information pits required for a CD or DVD have been applied. What is shown is labelling on the outer surface facing outwards during use. However, the promotional message can naturally also be provided in a different manner and on the opposite surface of the respective disc.

With an information carrier 1 according to the invention, direct advertising for sports brands, beverages, temporary employment organizations, media companies and the like can be effected. Such a device can also be used as a ticket in a lottery or sweepstake or as a collectible. For instance, of a large number of information carriers such as CDs, a limited number can be provided with a message such as a (alpha)numerical indication, which information carriers give a right to a prize. Optionally, specific messages can be provided giving a right to different prizes. The respective information carriers can also be designed as collectibles, for instance through special pictures, texts and the like.

The message 5 can be pressed or printed on the surface 7 of the CD 1 yet it is preferred that the message 5 and, optionally, a field 8 is provided for use by the user of the CD 1 through in mold labelling. The message can also be provided as, for instance, a sticker. Optionally, the reflection layer or the light influenceable layer 3 can be provided through in molding labelling too, preferably together with the message 5.

The invention is not limited in any manner to the embodiments represented in the description and the drawing. Many variations thereon are possible within the invention.

For instance, an information carrier according to the invention can be designed as a DVD. The or each message can be printed or pressed onto the CD, optionally online, while the message on the different information carriers can be modified. Optionally, a short commercial message can be included on the CD in image or sound, as electronic information. Also, in addition to or instead of on the information carrier, the or each message can be provided on a storage box therefor, optionally such that a part is visible on the information carrier and a part is visible on the box, which box is at least partly transparent so that when the information carrier is confined the box, the entire message becomes visible.

These and many comparable variations are understood to fall within the framework of the invention as outlined by the claims.

1. An information carrier of a type on which electronic information can be provided, such as a DVD or CD rewritable or recordable or a diskette, which information carrier is substantially free of such electronic information, wherein on a surface of the information carrier and/or in electronic form at least one commercial message has been provided which is not related to the supplier or producer of the respective information carrier.

2. An information carrier according to claim 1, wherein said promotional message has been provided on a side which, during use of the information carrier in a player suitable thereto, is usually turned upwards towards the user, at least that upon insertion of the information carrier into said player the promotional message is visible to the user.

3. An information carrier according to claim 1, wherein the information carrier has a closed top face and bottom face.

4. An information carrier according to claim 1 , wherein only a part of the surface of the information carrier is taken up by the promotional message, while a further part of the respective surface of the information carrier is writable to the user.

5. An information carrier according to claim 1 , wherein the promotional message is at least partly included on a part that is detachable from the information carrier, in particular on an element provided in a central opening of the information carrier.

6. An information carrier according to claim 5, wherein said element is an element loosely provided in said opening.

7. An information carrier according to claim 1 , wherein the information carrier can include electronic information which is readable with the aid of light, in particular laser light, and is provided with a reflective layer, while said promotional message on the information carrier is provided in a colour which does not hinder the light for reading out the information carrier, the commercial message being at least visible on the side of the information carrier which, for playing the information carrier, is shone upon by said light.

8. An assembly of an information carrier of a type on which electronic information can be provided such as a DVD or CD rewritable or recordable or diskette, in particular according to claim 1, and a package therefor, wherein the information carrier is substantially free of such electronic information while on a surface of the information carrier and/or on the package at least one promotional message has been provided containing information which is not related to the supplier or producer of the respective information carrier.

9. A series of information carriers according to claim 1 , wherein of said series, at least one information carrier and/or package is provided with said promotional message and at least one other information carrier and/or package is not provided with such a promotional message.

10. A method for transferring information, wherein on a substantially unrecorded information carrier such as a DVD or CD rewritable, recordable or diskette or a package therefor, prior to it being supplied to a user, in particular to a consumer, a message, in particular a promotional message is provided which message contains information which is not related to the respective information carrier.

11. A method according to claim 10, wherein on said information carrier information related to the information carrier as well as said promotional message are provided.

12. A method according to claim 10, wherein by or on behalf of the supplier of the information carriers messages from third parties, companies, institutions or persons not related to the supplier are collected, which are provided on said information carrier.

13. A method according to claim 1 , wherein as a message at least a product or company logo is provided.

14. A method for transferring information, wherein on a substantially unrecorded information carrier such as a DVD or CD rewritable, recordable or a diskette, prior to it being supplied to a user, in particular a consumer, in an electronic manner an informative or promotional message is provided which message contains information not related to the respective information carrier and, upon at least the first use of the information carrier in a player suitable thereto, will be represented on a playback unit suitable to that end.

15. A method for advertising, wherein a promotional message is provided on a substantially blank information carrier for digital information, which advertisement is not related to the supplier and/or producer of the information carrier.

16. A method according to claim 15, wherein the promotional message is provided on a front or rear side, in particular a rear side of a CD rewritable or recordable or a front or rear side of a DVD rewritable or recordable or such information carrier.

17. A method according to claim 10 any one of claims 10 16, wherein as promotional message an element is provided serving as a ticket in a lottery or as collectible.

18. A method according to claim 1 , wherein the promotional message is at least partly provided on an element which element has been or is provided in a central opening of the information carrier.

19. A method for providing messages on substantially unrecorded recordable and/or rewritable CDs, DVDs or diskette, wherein:
by a first offeror, the unrecorded CDs, DVDs or diskettes are manufactured, at least offered;
by a second offeror, messages are made available, which messages are not related to the first offeror or to information to be recorded on the CDs, DVDs or diskettes;
which messages are provided by the first offeror on the CDs, DVDs or diskettes; and
wherein the first offeror or a third offeror offer the CDs DVDs or diskettes thus provided with a message to users.

20. A method according to claim 19, wherein the message is provided in the form of a print of a surface of the information carrier.

21. A method according to claim 19, wherein the message is provided through in mould labelling.

22. An assembly of information carriers according to claim 8 wherein at least one information carrier and/or package is provided with said promotional message and at least one other information carrier and/or package is not provided with such a promotional message.
